(19) United States
(12) Patent Application Publication
(10) Pub. No.: US 2013/0141446 A1
(43) Pub. Date: Jun. 6, 2013

(54) Method and Apparatus for Servicing Page Fault Exceptions

(71) Applicants: Robert Scott Hartog, Windemere, FL (US); Ralph Clay Taylor, Deland, FL (US); Michael Mantor, Orlando, FL (US); Thomas R. Woller, Austin, TX (US); Kevin McGrath, Los Gatos, CA (US); Sebastien Nussbaum, Lexington, MA (US); Nuwan Jayasena, Sunnyvale, CA (US); Rex McCrary, Oviedo, FL (US); Philip J. Rogers, Pepperell, MA (US); Mark Leather, Los Gatos, CA (US)

(72) Inventors: Robert Scott Hartog, Windemere, FL (US); Ralph Clay Taylor, Deland, FL (US); Michael Mantor, Orlando, FL (US); Thomas R. Woller, Austin, TX (US); Kevin McGrath, Los Gatos, CA (US); Sebastien Nussbaum, Lexington, MA (US); Nuwan Jayasena, Sunnyvale, CA (US); Rex McCrary, Oviedo, FL (US); Philip J. Rogers, Pepperell, MA (US); Mark Leather, Los Gatos, CA (US)

(73) Assignee: Advanced Micro Devices, Inc., Sunnyvale, CA (US)

(21) Appl. No.: 13/311,829

(22) Filed: Dec. 6, 2011

(51) Int. Cl. G06T 1/00; G06F 12/10

(52) U.S. Cl. 345/522; 711/203; 711/207; 711/E12.061

(57) ABSTRACT

A method, apparatus and computer readable media for servicing page fault exceptions in a accelerated processing device (APD). A page fault related to a wavefront is detected. A fault handling request to a translation mechanism is sent when the page fault is detected. A fault handling response corresponding to the detected page fault from the translation mechanism is received. Confirmation that the detected page fault has been handled through performing page mapping based on the fault handling response is received.

### BACKGROUND

1. Field of the Invention

The present invention is generally directed to computing systems. More particularly, the present invention is directed to a method and apparatus for servicing page fault exceptions.

2. Background Art

The desire to use a graphics processing unit (GPU) for general computation has become much more pronounced recently due to the GPU's exemplary performance per unit power and/or cost. The computational capabilities for GPUs, generally, have grown at a rate exceeding that of the corresponding central processing unit (CPU) platforms. This growth, coupled with the explosion of the mobile computing market and its necessary supporting server/enterprise systems, has been used to provide a specified quality of desired user experience. Consequently, the combined use of CPUs and GPUs for executing workloads with data parallel content is becoming a volume technology.

However, GPUs have traditionally operated in a constrained programming environment, available only for the acceleration of graphics. These constraints arose from the fact that GPUs did not have as rich a programming ecosystem as CPUs. Their use, therefore, has been mostly limited to two dimensional (2D) and three dimensional (3D) graphics and a few leading edge multimedia applications, which are already accustomed to dealing with graphics and video application programming interfaces (APIs).

With the advent of multi-vendor supported OpenCL® and DirectCompute®, standard APIs and supporting tools, the limitations of the GPUs in traditional applications has been extended beyond traditional graphics. Although OpenCL and DirectCompute are a promising start, there are many hurdles remaining to creating an environment and ecosystem that allows the combination of the CPU and GPU to be used as fluidly as the CPU for most programming tasks.

Existing computing systems often include multiple processing devices. For example, some computing systems include both a CPU and a GPU on separate chips (e.g., the CPU might be located on a motherboard and the GPU might be located on a graphics card) or in a single chip package. Both of these arrangements, however, still include significant challenges associated with (i) separate memory systems, (ii) efficient scheduling, (iii) providing quality of service (QoS) guarantees between processes, (iv) programming model, and (v) compiling to multiple target instruction set architectures (ISAs)—all while minimizing power consumption.

For example, the discrete chip arrangement forces system and software architects to utilize chip to chip interfaces for each processor to access memory. While these external interfaces (e.g., chip to chip) negatively affect memory latency and power consumption for cooperating heterogeneous processors, the separate memory systems (i.e., separate address spaces) and driver managed shared memory create overhead that becomes unacceptable for fine grain offload.

In another example, GPUs running tasks can encounter arbitrary page faults when requesting translations that require system memory to be accessed. GPUs currently operate within their own memory space managed by GPU driver software. Having GPU driver software provides some guarantees to GPU hardware about page availability. However, the software does not provide those guarantees for a GPU operating on paged system memory managed by the operating system (OS).

### SUMMARY OF EMBODIMENTS

Therefore, what is needed are methods and apparatus for servicing page fault exceptions.

Although GPUs, accelerated processing units (APUs), and general purpose use of the graphics processing unit (GPGPU) are commonly used terms in this field, the expression “accelerated processing device (APD)” is considered to be a broader expression. For example, APD refers to any cooperating collection of hardware and/or software that performs those functions and computations associated with accelerating graphics processing tasks, data parallel tasks, or nested data parallel tasks in an accelerated manner with respect to resources such as conventional CPUs, conventional GPUs, and/or combinations thereof

More specifically, embodiments of the present invention provide a method, system, apparatus and computer program product medium for detecting a fault related to a wavefront that has requested a translation by device processor. A page fault resulting from a failed page translation is detected, the fault being associated with a wavefront that has requested translation. A fault handling request is sent to a translation mechanism when the page fault is detected. A fault handling response is received that corresponds to the fault handling request. A confirmation is received that the detected page fault has been resolved through performing page mapping based on the fault handling response.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention. Various embodiments of the present invention are described below with reference to the drawings, wherein like reference numerals are used to refer to like elements throughout.

FIG. 1A is an illustrative block diagram of a processing system in accordance with embodiments of the present invention.

FIG. 1B is an illustrative block diagram illustration of the APD illustrated in FIG. 1A.

FIG. 2 is an illustrative block diagram of a processing system equipped to service faults, according to an embodiment of the present invention.

FIG. 3 is a flowchart illustrating a method for servicing faults on an APD, according to an embodiment of the present invention.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment, Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

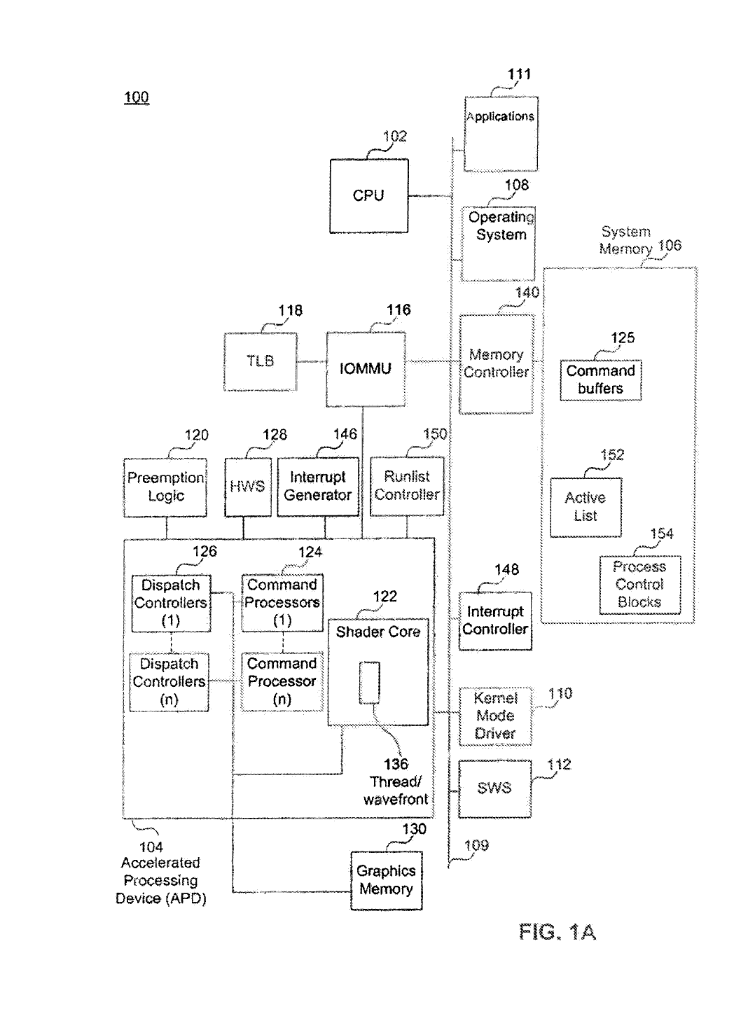

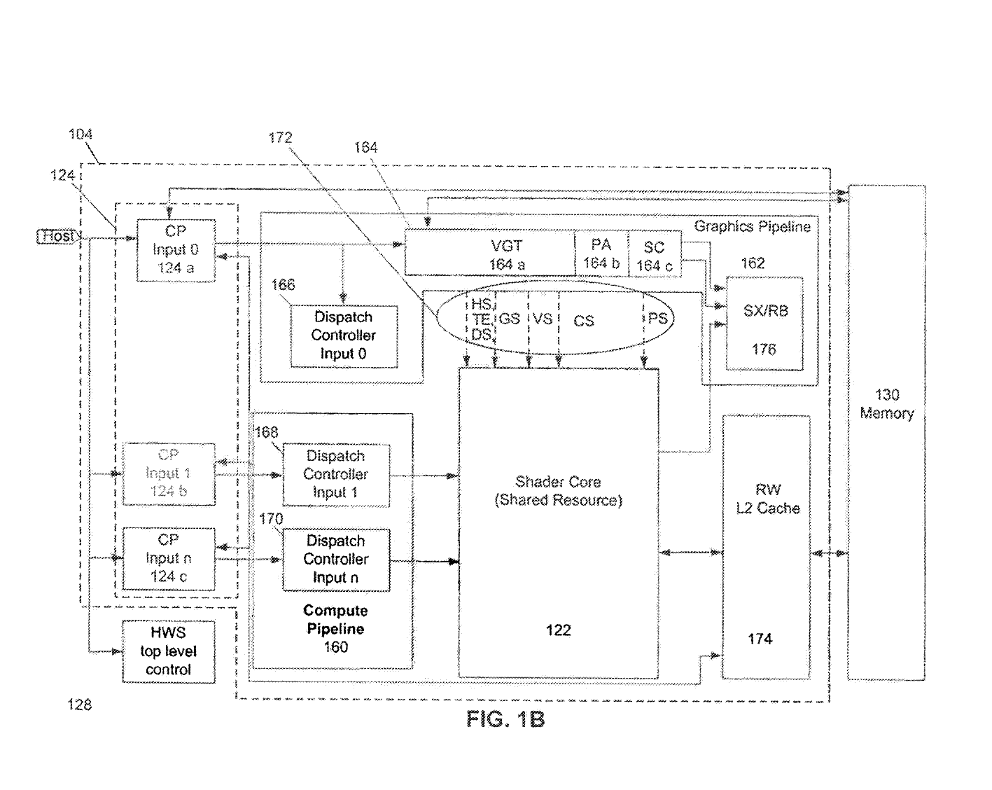

FIG. 1A is an exemplary illustration of a unified computing system 100 including a CPU 102 and an APD 104. CPU 102 can include one or more single or multi core CPUs. In one embodiment of the present invention, the system 100 is formed on a single silicon die or package, combining CPU 102 and APD 104 to provide a unified programming and execution environment. This environment enables the APD 104 to be used as fluidly as the CPU 102 for some programming tasks. However, it is not an absolute requirement of this invention that the CPU 102 and APD 104 be formed on a single silicon die. In some embodiments, it is possible for them to be formed separately and mounted on the same or different substrates.

In one example, system 100 also includes a memory 106, an OS 108, and a communication infrastructure 109. The OS 108 and the communication infrastructure 109 are discussed in greater detail below.

The system 100 also includes a kernel mode driver (KMD) 110, a software scheduler (SWS) 112, and a memory management unit 116, such as input/output memory management unit (IOMMU). Components of system 100 can be implemented as hardware, firmware, software, or any combination thereof. A person of ordinary skill in the art will appreciate that system 100 may include one or more software, hardware, and firmware components in addition to, or different from, that shown in the embodiment shown in FIG. 1A.

In one example, a driver, such as KMD 110, typically communicates with a device through a computer bus or communications subsystem to which the hardware connects. When a calling program invokes a routine in the driver, the driver issues commands to the device. Once the device sends data back to the driver, the driver may invoke routines in the original calling program. In one example, drivers are hardware-dependent and operating-system-specific. They usually provide the interrupt handling required for any necessary asynchronous time-dependent hardware interface. Device drivers, particularly on modern Windows platforms, can run in kernel-mode (Ring 0) or in user-mode (Ring 3).

A benefit of running a driver in user mode is improved stability, since a poorly written user mode device driver cannot crash the system by overwriting kernel memory. On the other hand, user/kernel-mode transitions usually impose a considerable performance overhead, thereby prohibiting user mode-drivers for low latency and high throughput requirements. Kernel space can be accessed by user module only through the use of system calls. End user programs like the UNIX shell or other GUI based applications are part of the user space. These applications interact with hardware through kernel supported functions.

CPU 102 can include (not shown) one or more of a control processor, field programmable gate array (FPGA), application specific integrated circuit (ASIC), or digital signal processor (DSP). CPU 102, for example, executes the control logic, including the OS 108, KMD 110, SWS 112, and applications 111, that control the operation of computing system 100. In this illustrative embodiment, CPU 102, according to one embodiment, initiates and controls the execution of applications 111 by, for example, distributing the processing associated with that application across the CPU 102 and other processing resources, such as the APD 104.

APD 104, among other things, executes commands and programs for selected functions, such as graphics operations and other operations that may be, for example, particularly suited for parallel processing. In general, APD 104 can be frequently used for executing graphics pipeline operations, such as pixel operations, geometric computations, and rendering an image to a display. In various embodiments of the present invention, APD 104 can also execute compute processing operations, based on commands or instructions received from CPU 102.

For example, commands can be considered a special instruction that is not defined in the ISA and usually accomplished by a set of instructions in from a given ISA or a unique piece of hardware. A command may be executed by a special processor such a dispatch processor, command processor, or network controller. On the other hand, instructions can be considered, e.g., a single operation of a processor within a computer architecture. In one example, when using two sets of ISAs, some instructions are used to execute x86 programs and some instructions are used to execute kernels on APU/GPU compute unit.

In an illustrative embodiment, CPU 102 transmits selected commands to APD 104. These selected commands can include graphics commands and other commands amenable to parallel execution. These selected commands, that can also include compute processing commands, can be executed substantially independently from CPU 102.

APD 104 can include its own compute units (not shown), such as, but not limited to, one or more single instruction multiple data (SIMD) processing cores. As referred to herein, a SIMD is a math pipeline, or programming model, where a kernel is executed concurrently on multiple processing elements each with its own data and a shared program counter. All processing elements execute a strictly identical set of instructions. The use of predication enables work-items to participate or not for each issued command.

In one example, each APD 104 compute unit can include one or more scalar and/or vector floating-point units and/or arithmetic and logic units (ALUs). The APD compute unit can also include special purpose processing units (not shown), such as inverse-square root units and sine/cosine units. In one example, the APD compute units are referred to herein collectively as shader core 122.

Having one or more SIMDs, in general, makes APD 104 ideally suited for execution of data-parallel tasks such as are common in graphics processing.

Some graphics pipeline operations, such as pixel processing, and other parallel computation operations, can require that the same command stream or compute kernel be performed on streams or collections of input data elements. Respective instantiations of the same compute kernel can be executed concurrently on multiple compute units in shader core 122 in order to process such data elements in parallel. As referred to herein, for example, a compute kernel is a function containing instructions declared in a program and executed on an APU/APD compute unit. This function is also referred to as a kernel, a shader, a shader program, or a program.

In one illustrative embodiment, each compute unit (e.g., SIMD processing core) can execute a respective instantiation of a particular work-item to process incoming data.

In one example, a work-item is one of a collection of parallel executions of a kernel invoked on a device by a command. A work-item is executed by one or more processing elements as part of a work-group executing on a compute unit. A work-item is distinguished from other executions within the collection by its global ID and local ID.

In one example, a subset of work-items in a workgroup that execute simultaneously together on a single SIMD engine can be referred to as a wavefront 136. The width of a wavefront is a characteristic of the hardware SIMD engine. All wavefronts from a workgroup are processed on the same SIMD engine. Instructions across a wavefront are issued one at a time, and when all work-items follow the same control flow, each work-item executes the same program. An execution mask and work-item predication are used to enable divergent control flow within a wavefront, where each individual work-item can actually take a unique code path through the kernel. Partially populated wavefronts can be processed when a full set of work-items is not available at wavefront start time. Wavefronts can also be referred to as warps, vectors, or threads.

Commands can be issued one at a time for the wavefront. When all work-items follow the same control flow, each work-item can execute the same program. In one example, an execution mask and work-item predication are used to enable divergent control flow where each individual work-item can actually take a unique code path through a kernel driver. Partial wavefronts can be processed when a full set of work-items is not available at start time. For example, shader core 122 can simultaneously execute a predetermined number of wavefronts 136, each wavefront 136 comprising a predetermined number of work-items.

Within the system 100, APD 104 includes its own memory, such as graphics memory 130. Graphics memory 130 provides a local memory for use during computations in APD 104. Individual compute units (not shown)within shader core 122 can have their own local data store (not shown). In one embodiment, APD 104 includes access to local graphics memory 130, as well as access to the memory 106. In another embodiment, APD 104 can include access to dynamic random access memory (DRAM) or other such memories (not shown) attached directly to the APD 104 and separately from memory 106.

In the example shown, APD 104 also includes one or (n) number of command processors (CPs) 124. CP 124 controls the processing within APD 104. CP 124 also retrieves commands to be executed from command buffers 125 in memory 106 and coordinates the execution of those commands on APD 104.

In one example, CPU 102 inputs commands based on applications 111 into appropriate command buffers 125. As referred to herein, an application is the combination of the program parts that will execute on the compute units within the CPU and APD.

A plurality of command buffers 125 can be maintained with each process scheduled for execution on the APD 104.

CP 124 can be implemented in hardware, firmware, or software, or a combination thereof. In one embodiment, CP 124 is implemented as a reduced instruction set computer (RISC) engine with microcode for implementing logic including scheduling logic.

APD 104 also includes one or (n) number of dispatch controllers (DCs) 126. In the present application, the term dispatch refers to a command executed by a dispatch controller that uses the context state to initiate the start of the execution of a kernel for a set of work groups on a set of compute units.

DC 126 includes logic to initiate wavefronts of work-items in the shader core 122. In some embodiments, DC 126 can be implemented as part of CP 124.

System 100 also includes a hardware scheduler (HWS) 128 for selecting a process from a run list 150 for execution on APD 104. HWS 128 can select processes from run list 150 using round robin methodology, priority level, or based on other scheduling policies. The priority level, for example, can be dynamically determined. HWS 128 can also include functionality to manage the run list 150, for example, by adding new processes and by deleting existing processes from run-list 150. The run list management logic of HWS 128 is sometimes referred to as a run list controller (RLC).

In various embodiments of the present invention, when HWS 128 initiates the execution of a process from RLC 150, CP 124 begins retrieving and executing commands from the corresponding command buffer 125. In some instances, CP124 can generate one or more commands to be executed within APD 104, which correspond with commands received from CPU 102. In one embodiment, CP 124, together with other components, implements a prioritizing and scheduling of commands on APD 104 in a manner that improves or maximizes the utilization of the resources of APD 104 resources and/or system 100.

APD 104 can have access to, or may include, an interrupt generator 146. Interrupt generator 146 can be configured by APD 104 to interrupt the OS 108 when interrupt events, such as page faults, are encountered by APD 104. For example, APD 104 can rely on interrupt generation logic within IOMMU 116 to create the page fault interrupts noted above.

APD 104 can also include preemption and context switch logic 120 for preempting a process currently running within shader core 122. Context switch logic 120, for example, includes functionality to stop the process and save its current state (e.g., shader core 122 state, and CP 124 state).

As referred to herein, the term state can include an initial state, an intermediate state, and a final state. An initial state is a starting point for a machine to process an input data set according to a program in order to create an output set of data. There is an intermediate state, for example, that needs to be stored at several points to enable the processing to make forward progress. This intermediate state is sometimes stored to allow a continuation of execution at a later time when interrupted by some other process. There is also final state that can be recorded as part of the output data set

Preemption and context switch logic 120 can also include logic to context switch another process into the APD 104. The functionality to context switch another process into running on the APD 104 may include instantiating the process, for example, through the CP 124 and DC 126 to run on APD 104, restoring any previously saved state for that process, and starting its execution.

Memory 106 can include non-persistent memory such as DRAM (not shown). Memory 106 can store, e.g., processing logic instructions, constant values, and variable values during execution of portions of applications or other processing logic. For example, in one embodiment, parts of control logic to perform one or more operations on CPU 102 can reside within memory 106 during execution of the respective portions of the operation by CPU 102. The term “processing logic” or “logic,” as used herein, refers to control flow commands, commands for performing computations, and commands for associated access to resources.

During execution, respective applications, OS functions, processing logic commands, and system software can reside in memory 106. Control logic commands fundamental to OS 108 will generally reside in memory 106 during execution. Other software commands, including, for example, kernel mode driver 110 and software scheduler 112 can also reside in memory 106 during execution of system 100.

In this example, memory 106 includes command buffers 125 that are used by CPU 102 to send commands to APD 104. Memory 106 also contains process lists and process information (e.g., active list 152 and process control blocks 154). These lists, as well as the information, are used by scheduling software executing on CPU 102 to communicate scheduling information to APD 104 and/or related scheduling hardware. Access to memory 106 can be managed by a memory controller 140, which is coupled to memory 106. For example, requests from CPU 102, or from other devices, for reading from or for writing to memory 106 are managed by the memory controller 140.

Referring back to other aspects of system 100, IOMMU 116 is a multi-context memory management unit.

As used herein, context (sometimes referred to as process) can be considered the environment within which the kernels execute and the domain in which synchronization and memory management is defined. The context includes a set of devices, the memory accessible to those devices, the corresponding memory properties and one or more command-queues used to schedule execution of a kernel(s) or operations on memory objects. On the other hand, process can be considered the execution of a program for an application will create a process that runs on a computer. The OS can create data records and virtual memory address spaces for the program to execute. The memory and current state of the execution of the program can be called a process. The OS will schedule tasks for the process to operate on the memory from an initial to final state.

Referring back to the example shown in FIG. 1A, IOMMU 116 includes logic to perform virtual to physical address translation for memory page access for devices including APD 104. IOMMU 116 may also include logic to generate interrupts, for example, when a page access by a device such as APD 104 results in a page fault. IOMMU 116 may also include, or have access to, a translation lookaside buffer (TLB) 118. TLB 118, as an example, can be implemented in a content addressable memory (CAM) to accelerate translation of logical (i.e., virtual) memory addresses to physical memory addresses for requests made by APD 104 for data in memory 106.

In the example shown, communication infrastructure 109 interconnects the components of system 100 as needed. Communication infrastructure 109 can include (not shown)one or more of a peripheral component interconnect (PCI) bus, extended PCI (PCI-E) bus, advanced microcontroller bus architecture (AMBA) bus, accelerated graphics port (AGP), or such communication infrastructure. Communications infrastructure 109 can also include an Ethernet, or similar network, or any suitable physical communications infrastructure that satisfies an application's data transfer rate requirements. Communication infrastructure 109 includes the functionality to interconnect components including components of computing system 100.

In this example, OS 108 includes functionality to manage the hardware components of system 100 and to provide common services. In various embodiments, OS 108 can execute on CPU 102 and provide common services. These common services can include, for example, scheduling applications for execution within CPU 102, fault management, interrupt service, as well as processing the input and output of other applications.

In some embodiments, based on interrupts generated by an interrupt controller, such as interrupt controller 148, OS 108 invokes an appropriate interrupt handling routine. For example, upon detecting a page fault interrupt, OS 108 may invoke an interrupt handler to initiate loading of the relevant page into memory 106 and to update corresponding page tables.

OS 108 may also include functionality to protect system 100 by ensuring that access to hardware components is mediated through managed kernel functionality. In effect, OS 108 ensures that applications, such as applications 111, run on CPU 102 in user space. OS 108 also ensures that applications 111 invoke kernel functionality provided by the OS to access hardware and/or input/output functionality.

By way of example, applications 111 include various programs or commands to perform user computations that are also executed on CPU 102. The unification concepts can allow CPU 102 to seamlessly send selected commands for processing on the APD 104. Under this unified APD/CPU framework, input/output requests from applications 111 will be processed through corresponding OS functionality.

In one example, KMD 110 implements an application program interface (API) through which CPU 102, or applications executing on CPU 102 or other logic, can invoke APD 104 functionality. For example, KMD 110 can enqueue commands from CPU 102 to command buffers 125 from which APD 104 will subsequently retrieve the commands. Additionally, KMD 110 can, together with SWS 112, perform scheduling of processes to be executed on APD 104. SWS 112, for example, can include logic to maintain a prioritized list of processes to be executed on the APD.

In other embodiments of the present invention, applications executing on CPU 102 can entirely bypass KMD 110 when enqueuing commands.

In some embodiments, SWS 112 maintains an active list 152 in memory 106 of processes to be executed on APD 104. SWS 112 also selects a subset of the processes in active list 152 to be managed by HWS 128 in the hardware. In an illustrative embodiment, this two level run list of processes increases the flexibility of managing processes and enables the hardware to rapidly respond to changes in the processing environment. In another embodiment, information relevant for running each process on APD 104 is communicated from CPU 102 to APD104 through process control blocks (PCB) 154.

Processing logic for applications, OS, and system software can include commands specified in a programming language such as C and/or in a hardware description language such as Verilog, RTL, or netlists, to enable ultimately configuring a manufacturing process through the generation of maskworks/photomasks to generate a hardware device embodying aspects of the invention described herein.

A person of skill in the art will understand, upon reading this description, that computing system 100 can include more or fewer components than shown in FIG. 1A. For example, computing system 100 can include one or more input interfaces, non-volatile storage, one or more output interfaces, network interfaces, and one or more displays or display interfaces.

FIG. 1B is an embodiment showing a more detailed illustration of APD 104 shown in FIG. 1A. In FIG. 1B, CP 124 can include CP pipelines 124a, 124b, and 124c. CP 124 can be configured to process the command lists that are provided as inputs from command buffers 125, shown in FIG. 1A. In the exemplary operation of FIG. 1B, CP input 0 (124a) is responsible for driving commands into a graphics pipeline 162. CP inputs 1 and 2 (124b and 124c) forward commands to a compute pipeline 160.

Also provided is a controller mechanism 166 for controlling operation of HWS 128, which executes information passed from various graphics blocks.

In FIG. 1B, graphics pipeline 162 can include a set of blocks, referred to herein as ordered pipeline 164. As an example, ordered pipeline 164 includes a vertex group translator (VGT) 164a, a primitive assembler (PA) 164b, a scan converter (SC) 164c, and a shader-export, render-back unit (SX/RB) 176. Each block within ordered pipeline 164 may represent a different stage of graphics processing within graphics pipeline 162. Ordered pipeline 164 can be a fixed function hardware pipeline. Although other implementations that would be within the spirit and scope of the present invention can be used.

Although only a small amount of data may be provided as an input to graphics pipeline 162, this data will be amplified by the time it is provided as an output from graphics pipeline 162. Graphics pipeline 162 also includes DC 166 for counting through ranges within work-item groups received from CP pipeline 124a.

Compute pipeline 160 includes shader DCs 168 and 170. Each of the DCs are configured to count through ranges within work-item groups received from CP pipelines 124b and 124c.

The DCs 166, 168, and 170, illustrated in FIG. 1B, receive the input work groups, break the work groups down into wavefronts, and then forward the wavefronts to shader core 122.

Since graphics pipeline 162 is generally a fixed function pipeline, it is difficult to save and restore its state, and as a result, the graphics pipeline 162 is difficult to context switch. Therefore, in most cases context switching, as discussed herein, does not pertain to context switching among graphics processes.

Shader core 122 can be shared by graphics pipeline162 and compute pipeline 160. Shader core 122 can be a general processor configured to run wavefronts. Graphics pipeline 162 and compute pipeline 160 are configured to determine the appropriate wavefronts to process.

In one example, all work within compute pipeline 160 is processed within shader core 122. Shader core 122 runs programmable software code and includes various forms of data, such as state data. Compute pipeline 160 reads and writes into graphics memory 130 through a local memory, such as an L2 cache 174. Compute pipeline 160, however, does not send work to graphics pipeline 162 for processing. After processing of work within graphics pipeline 162 has been completed, the completed work is processed through a render back unit 176, which does depth and color calculations, and then writes its final results to graphics memory 130.

A disruption in the QoS occurs when all work-items are unable to access APD resources. Embodiments of the present invention efficiently and simultaneously launch two or more tasks within an accelerated processing device 104, enabling all work-items to access to APD resources. In one embodiment, a unique APD input scheme enables all work-items to have access to the APD's resources in parallel by managing the APD's workload. When the APD's workload approaches maximum levels, (e.g., during attainment of maximum I/O rates), this unique APD input scheme ensures that otherwise unused processing resources can be simultaneously utilized. A serial input stream, for example, can be abstracted to appear as parallel simultaneous inputs to the APD.

By way of example, each of the CPs 124 can have one or more tasks to submit as inputs to the APD 104, with each task can representing multiple wavefronts. After a first task is submitted as an input, this task may be allowed to ramp up, over a period of time, to utilize all the APD resources necessary for completion of the task. By itself, this first task may or may not reach a predetermined maximum APD utilization threshold. However, as other tasks are enqueued and are waiting to be processed within the APD 104, allocation of the APD resources can be managed to ensure that all of the tasks can simultaneously use the APD 104, each achieving a percentage of the APD's maximum utilization. This simultaneous use of the APD 104 by multiple tasks, and their combined utilization percentages, ensures that a predetermined maximum APD utilization threshold is achieved.

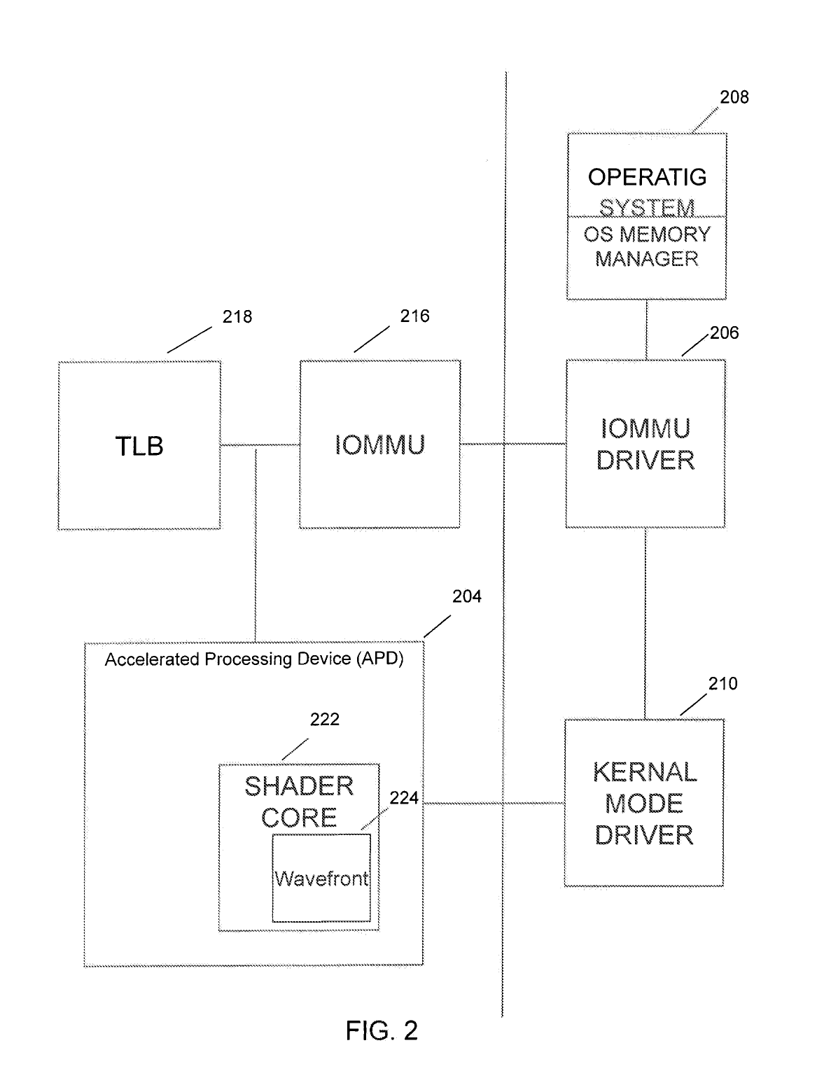

FIG. 2 shows a system 200, according to an embodiment of the present invention. For example, system 200 can be a mechanism for servicing page fault exceptions. In the embodiment shown, system 200 includes a APD 204 having a shader core 222, a driver 206, an OS 208, a kernel mode driver 210, a translation system 216, and a TLB 218.

In one example, the translation mechanism 216 can be a memory management unit MMU or an IOMMU. The IOMMU 216 may be incorporated in the APD 104, may be incorporated in another memory management unit such as a memory controller, or may be implemented separately. The IOMMU 216 includes the functionality to translate between the virtual memory address space as seen by the APD 104 and the system memory physical address space.

In one example, the TLB 218 is a cache that stores virtual addresses, which allow translations to be mapped from a page table (not shown) of OS 208. The TLB 218 can be implemented in the IOMMU 116 the APD 104, or separately. The TLB 218 is a cache, typically implemented in a CAM, which performs translation between a system memory physical address space and a virtual address space in a more efficient manner than by using page table lookup.

In an exemplary operation, the APD 204 sends a request to the IOMMU 216 for a page translation related to a wavefront 224 within the shader core 222. The IOMMU 216 searches the TLB 218 for a virtual address to a physical memory location. If the IOMMU 216 cannot find a requested page translation, a translation response is sent to the APD 204 indicating that the request was not located in the TLB 216. The translation response can be in the form of a page fault notification or a TLB miss. Upon receiving the fault notification from the IOMMU 216, a faulted wavefront is suspended. The APD 204 then sends a fault handling request to the IOMMU 216 to perform page mapping.

In this example, the IOMMU 216 receives the fault handling request from the APD 204. The IOMMU 216 then communicates a fault handling request to IOMMU driver 206. The IOMMU driver 206 receives the fault handling request and communicates with the OS 208. In another example, the OS 208 can include an OS memory manager that is used to receive the fault handling request from IOMMU driver 206.

The OS 208 then performs steps to handle the fault. For example, the OS 208 can handle the fault by performing address allocations, updating any page misses, or updating page tables. The OS 208 sends a response to the IOMMU driver 206. Once the fault handling request is completed, the IOMMU driver 206 sends a fault handling response to the IOMMU 216 indicating that the request has been completed. The IOMMU 216 communicates to the APD 204 that the fault handling request has been handled.

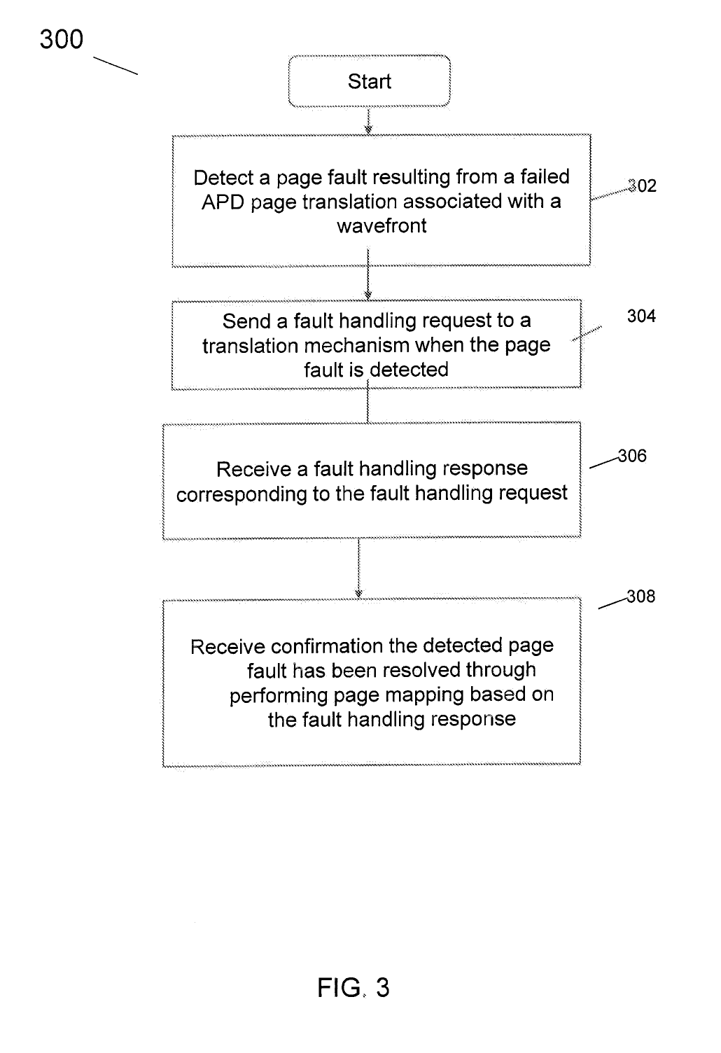

FIG. 3 is a flowchart depicting an exemplary method 300, according to embodiment of the present invention. For example, method 300 can operate on system 100 in FIGS. 1A and 1B. In one example, method 300 can be used for servicing faults in an APD. The method 300 may not occur in the order shown, or require all the steps.

In step 302, a page fault is detected that results from a failed APD page translation associated with a wavefront that has requested translation.

In step 304, a fault handling request is sent to a translation mechanism when the page fault is detected. The translation mechanism can be a memory management unit (MMU) or an IOMMU. The IOMMU may be incorporated into the APD, may be incorporated into a MMU, may be incorporated into a memory controller, or implemented separately. The IOMMU can translate between a virtual memory address space and a physical address space within a system memory.

In step 306, a fault handling response is received that corresponds to the fault handling request. For example, the IOMMU attempts to retrieve the address translation and determine that the data is not available in the memory.

In step 308, confirmation is received that the detected page fault has been resolved through performing page mapping based on the fault handling response.

For example, an IOMMU initiates a series of steps to perform the necessary page mapping, confirmation of which is transmitted to the APD. In one example, the APD can retry the fault wavefronts periodically to see if outstanding faults have been satisfied.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for servicing page faults within an accelerated processing device (APD), comprising:
sending a fault handling request to a translation mechanism when a page fault is detected;
receiving a fault handling response corresponding to the fault handling request; and
receiving confirmation the detected page fault has been resolved through performing page mapping based on the fault handling response.

2. The method of claim 1, wherein the sending the fault handling request comprises:
receiving, at an input output memory management unit (IOMMU) driver of the APD, the fault handling request;
sending, using the IOMMU driver, the fault handling request to an operating system (OS);
receiving, at the IOMMU driver, a fault handling completion signal from the OS; and
transmitting, to an IOMMU, the fault handling completion signal.

3. The method of claim 2, further comprising receiving at the IOMMU driver the fault handling completion signal from a kernel mode driver (KMD).

4. The method of claim 1, further comprising periodically retrying the faulted wavefronts to determine if outstanding faults have been satisfied.

5. The method of claim 1, wherein the fault includes at least one of a page fault, a translation lookaside buffer (TLB) and a memory exception.

6. The method of claim 1, further comprising using a memory controller, an IOMMU or a memory management unit (MMU) as the translation mechanism.

7. The method of claim 1, wherein the receiving a fault handling response includes performing page mapping based upon the fault handling response.

8. A computer readable medium having stored thereon computer executable instructions that, if executed by a computing device, causes the computing device to perform a method for servicing page faults within an accelerated processing device (APD), comprising:
detecting a page fault from a failed APD translation related to a wavefront;
sending a fault handling request to a translation mechanism when the page fault is detected;
receiving a fault handling response corresponding to the detected page fault from the translation mechanism; and
receiving confirmation the detected page fault has been handled through performing page mapping based on the fault handling response.

9. The method of claim 8, wherein the sending the fault handling request comprises:
receiving, at an input output memory management unit (IOMMU) driver of the APD, the fault handling request;
sending, using the IOMMU driver, the fault handling request to an operating system (OS);
receiving, at the IOMMU driver, a fault handling completion signal from the OS; and
transmitting, to tan IOMMU, the fault handling completion signal.

10. The method of claim 9, further including the step of receiving the fault handling completion signal from a kernel mode driver (KMD).

11. The method of claim 8, further comprising periodically retrying the faulted wavefronts to see if outstanding faults have been satisfied.

12. The method of claim 8, wherein the fault includes at least one of a page fault, a translation lookaside buffer (TLB) or a memory exception.

13. The method of claim 8, further comprising using a memory controller, an IOMMU or a memory management unit (MMU) as the translation mechanism.

14. An apparatus, comprising:
a memory; and
a graphics processing device coupled to the memory, wherein the graphics processing device is configured to, based on instructions stored in the memory, to:
detect a page fault related to a wavefront that has requested a translation;
send a fault handling request to a translation mechanism when the page fault is detected;
receive a fault handling response corresponding to the detected page fault from the translation mechanism; and
receive confirmation the detected page fault has been handled through performing page mapping based on the fault handling response.

15. The apparatus of claim 14, wherein upon receiving the fault handling request the translation mechanism is configured to send the fault handling request to an operating system.

16. The apparatus of claim 15, wherein upon completion of the fault handling request the operating system transmits a fault handling completion signal to an input output memory management unit (IOMMU).

17. The apparatus of claim 14, wherein the translation mechanism receives the fault handling completion signal from a kernel mode driver (KMD).

18. The apparatus of claim 14, further comprising using a memory controller, IOMMU or memory management unit (MMU) as the translation mechanism.

19. The apparatus of claim 14, wherein the faulted wavefronts are periodically retried to see if outstanding faults have been satisfied.

20. The apparatus of claim 14, wherein the fault includes at least one of a page fault, a translation lookaside buffer (TLB) and a memory exception.
